(19) United States
(12) Patent Application Publication
(10) Pub. No.: US 2020/0144771 A1
(43) Pub. Date: May 7, 2020

(54) SHIELDED-CABLE PASS-THROUGH ASSEMBLY WITH BOUNDRY CONTACT

(71) Applicant: Delphi Electric Center (Shanghai) Co., Shanghai (CN)

(72) Inventor: Anyang Zhang, Shanghai (CN)

(21) Appl. No.: 16/473,387

(22) PCT Filed: Dec. 30, 2016
(86) PCT No.: PCT/CN2016/113566

§ 371 Date: Jun. 25, 2019

(51) Int. Cl. H01R 13/6593; H01R 13/502

(52) U.S. Cl. CPC H01R 13/6593; H01R 13/502

(57) ABSTRACT

A shielded-cable pass-through assembly configured to provide electrical contact between a shielding-layer of a shielded-cable and a boundary through which the shielded-cable passes includes a metallic-sleeve and a contact-terminal. The metallic-sleeve defines a shield-surface used to make electrical contact with a shielding-layer of a shielded-cable. The contact-terminal defines a contact-feature used to make electrical contact with the boundary through which the shielded-cable passes. The contact-terminal also defines a plurality of inner-contact-fingers extending from the contact-terminal in a longitudinal-direction parallel to a longitudinal-axis of the shielded-cable. The plurality of inner-contact-fingers is urged in a radial-direction to make electrical contact with a contact-surface of the metallic-sleeve after the assembly is assembled.

### CROSS-REFERENCE TO RELATED APPLICATIONS

This application is a national stage application under 35 U.S.C. § 371 of PCT Application Number PCT/CN16/113566 having an international filing date of Dec. 30, 2016, which designated the United States, the entire disclosure of which is hereby incorporated herein by reference.

### TECHNICAL FIELD OF INVENTION

This disclosure generally relates to a shielded-cable pass-through assembly, and more particularly relates to the interface between a metallic-sleeve that makes electrical contact with a shielding-layer of a shielded-cable and a contact-terminal that makes electrical contact with a boundary through which the shielded-cable passes.

### BACKGROUND OF INVENTION

It is sometimes desirable to provide electrical contact between a shielding-layer of a shielded-cable and a boundary through which the shielded-cable passes. However, many of the proposed solutions are undesirably expensive and/or complex and/or unreliable.

### SUMMARY OF THE INVENTION

In accordance with one embodiment, a shielded-cable pass-through assembly configured to provide electrical contact between a shielding-layer of a shielded-cable and a boundary through which the shielded-cable passes is provided. The assembly includes a metallic-sleeve and a contact-terminal. The metallic-sleeve defines a shield-surface used to make electrical contact with a shielding-layer of a shielded-cable. The contact-terminal defines a contact-feature used to make electrical contact with the boundary through which the shielded-cable passes. The contact-terminal also defines a plurality of inner-contact-fingers extending from the contact-terminal in a longitudinal-direction parallel to a longitudinal-axis of the shielded-cable. The plurality of inner-contact-fingers is urged in a radial-direction to make electrical contact with a contact-surface of the metallic-sleeve after the assembly is assembled.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is an exploded view of a shielded-cable pass-through assembly in accordance with one embodiment;

FIG. 2 is a sectional view of the shielded-cable pass-through assembly of FIG. 1 in accordance with one embodiment;

FIGS. 3A, 3B, and 3C are views of parts used to form the shielded-cable pass-through assembly of FIGS. 1 and 2 in accordance with one embodiment;

FIG. 4 is a close-up sectional side view of part of the assembly of FIG. 1; and

FIG. 5 is a close-up sectional side view of part of the assembly of FIG. 4.

### DETAILED DESCRIPTION

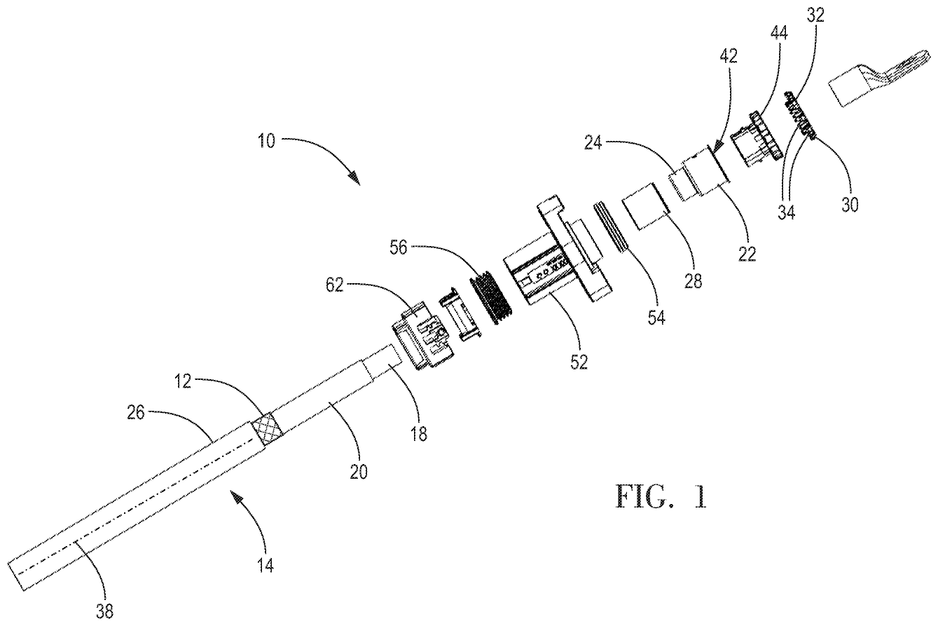

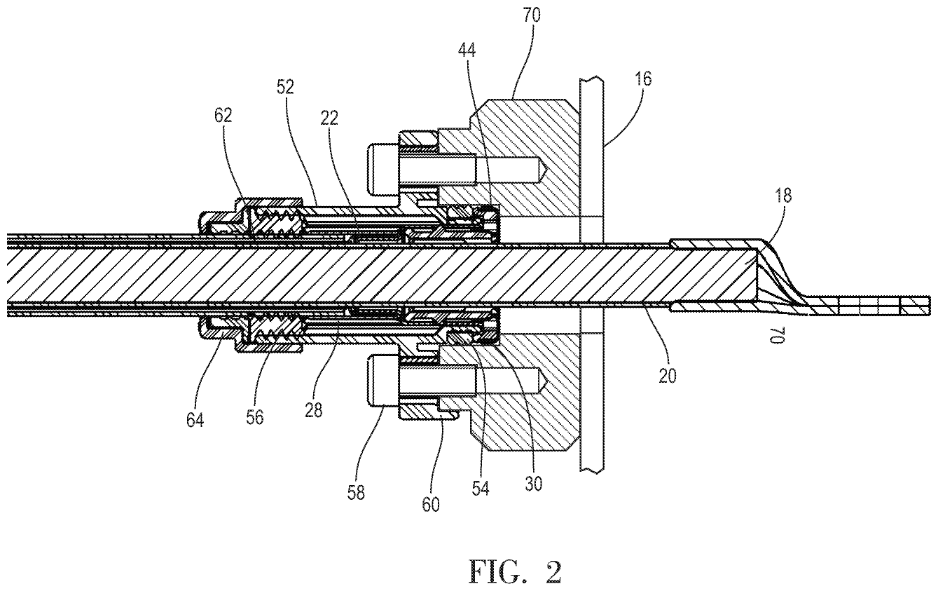

FIGS. 1 and 2 illustrate a non-limiting example of a shielded-cable pass-through assembly 10, hereafter referred to as the assembly 10, which is generally configured to provide electrical contact between a shielding-layer 12 of a shielded-cable 14 and a boundary 16 (FIG. 2) through which the shielded-cable 14 passes. In this example the shielded-cable 14 is illustrated as having a single-conductor 18 covered or wrapped by an insulation-layer 20, where the single-conductor 18 may be sized to be suitable for conducting current from a battery (not shown) in an electric-vehicle (not shown). However, the single-conductor 18 is not a requirement as it is contemplated that multiple-conductors may be covered by the insulation-layer 20 with the shielding-layer 12 providing electro-magnetic protection to the multiple-conductors. It is also contemplated that the features and parts of the assembly 10 could be duplicated in parallel to form a unitized 2-way, 3-way, or more-way assembly for multiple parallel instances of the single-conductor 18. For reliability and durability reasons it is preferred that the shielding-layer 12 be a braided wire type shielding. However, this is not a requirement as it is contemplated that the shielding-layer 12 could be formed of metallic-foil, with an optional single wire conductor, as will be recognized by those in the art.

The boundary 16 may be a metal body panel of a vehicle or enclosure for electrical equipment. The boundary 16 may include an interface 70 such as the interface which is shown by Marsh et al. in U.S. Pat. No. 8,585,415 issued Nov. 19, 2013, or corresponding Chinese Patent Number 102341965 issued Jul. 15, 2015; see reference number 118 in those documents. The interface 70 is preferably formed of metal and may be welded or otherwise attached to the boundary 16 in a manner that provides for an electrical connection between the interface 70 and the boundary 16. The assembly 10 may also include various seals, fixtures, and fasteners used to attach the assembly 10 to the interface or boundary 16.

The assembly 10 includes a metallic-sleeve 22 that defines a shield-surface 24 used to make electrical contact with the shielding-layer 12 of a shielded-cable 14. The shielded-cable 14 may be prepared (i.e. stripped) as suggested in FIG. 1 by removing portions of the outer-cover 26, the shielding-layer 12, and the insulation-layer 20. The portion of the metallic-sleeve 22 that defines the shield-surface 24 is typically sized to slide over the insulation-layer 20 and underneath the shielding-layer 12. The metallic-sleeve 22 may be formed of brass, plated steel, or any other material suitable to make a reliable electrical connection with the shielding-layer 12.

The assembly 10 may also include a ferrule 28 that is crimped over the shielding-layer 12 around where the shielding-layer 12 makes contact with the shield-surface 24 of the metallic-sleeve 22 to urge the shielding-layer 12 of the shielded-cable 14 into reliable electrical contact with the shield-surface 24. Like the metallic-sleeve 22, the ferrule 28 may be formed of brass, plated steel, or any other material suitable to crimp and thereby make a reliable electrical connection between with the shielding-layer 12 and the shield-surface 24.

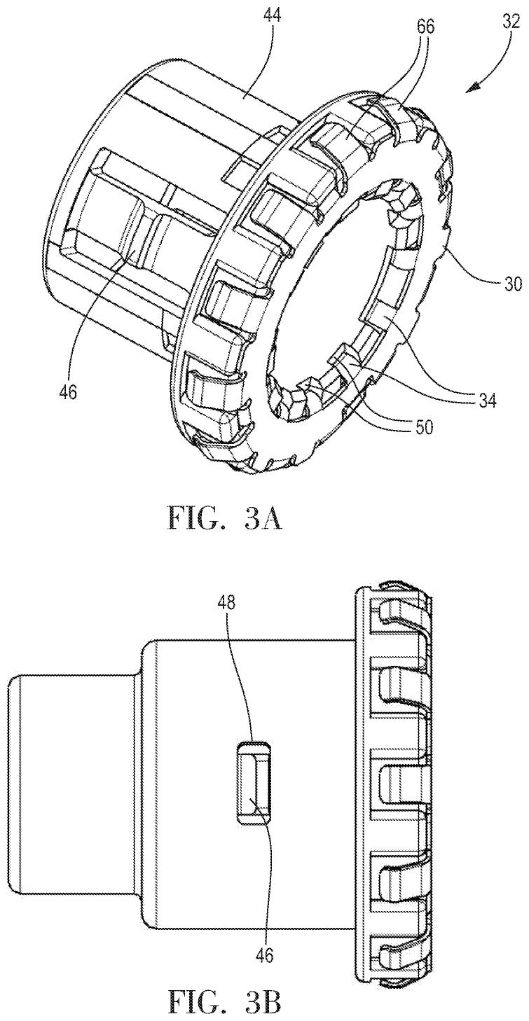

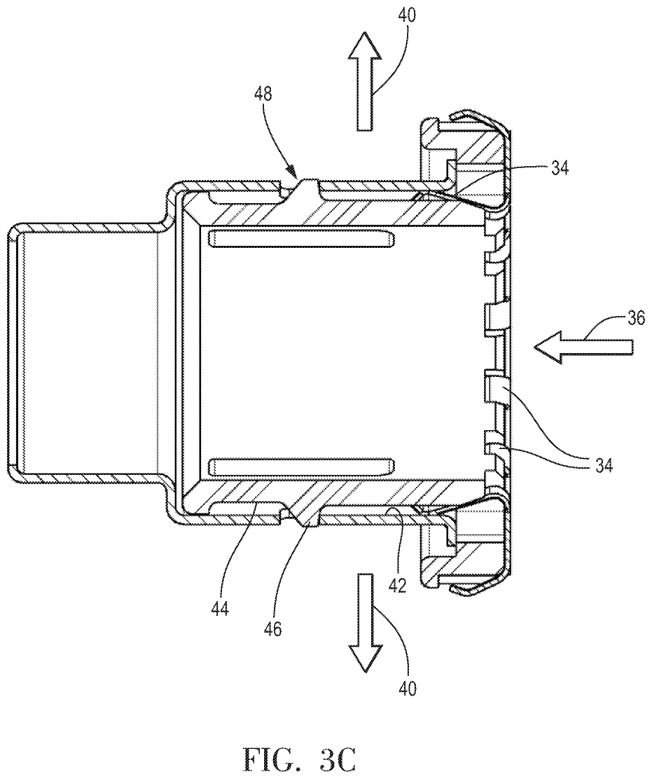

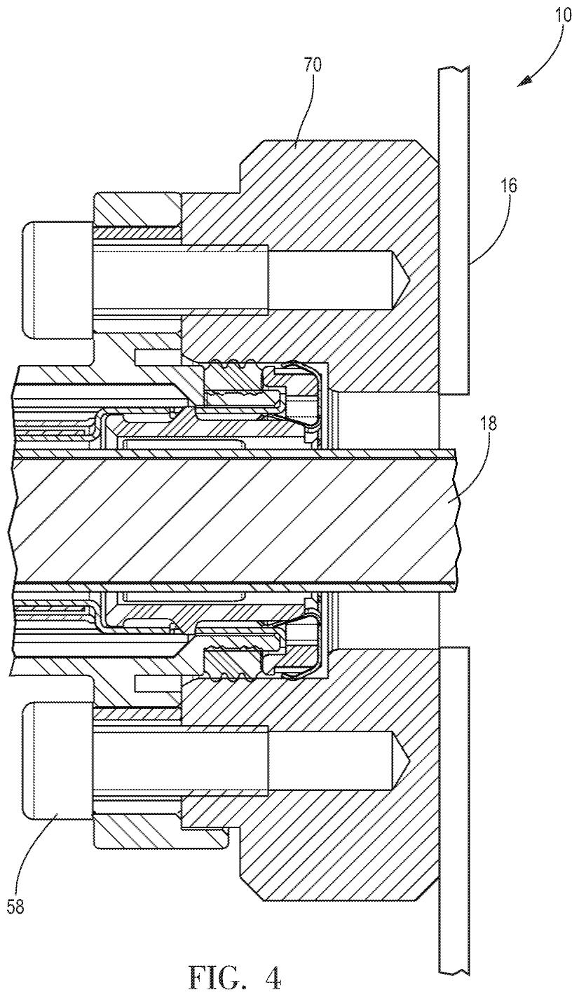

The assembly 10 includes a contact-terminal 30 that defines a contact-feature 32 (FIG. 3A) that may be used to make electrical contact with the boundary 16 when the assembly 10 is attached to the boundary 16. The contact-terminal 30 includes or defines a plurality of inner-contact-fingers 34 extending from the contact-terminal 30 in a longitudinal-direction 36 (FIG. 3C) parallel to a longitudinal-axis 38 (FIG. 1) of the shielded-cable 14. The material used to form the contact-terminal 30 (e.g. beryllium-copper) and the shape of the inner-contact-fingers cooperate so that the plurality of inner-contact-fingers 34 are urged in a radial-direction 40 (FIG. 3C) to make electrical contact with a contact-surface 42 of the metallic-sleeve 22 after the assembly 10 is assembled. That is, the plurality of inner-contact-fingers 34 maintains a spring-loaded contact with the contact-surface 42 once assembled. While the contact-surface 42 is shown in this non-limiting example as being on the inside of the metallic-sleeve 22 so that the radial-direction 40 is radially outward, this is not a requirement. It is contemplated that contact-surface 42 could be on the outside of the metallic-sleeve 22 and the plurality of inner-contact-fingers 34 could be configured to be urged or press against the metallic-sleeve 22 from the outside in a radially inward direction.

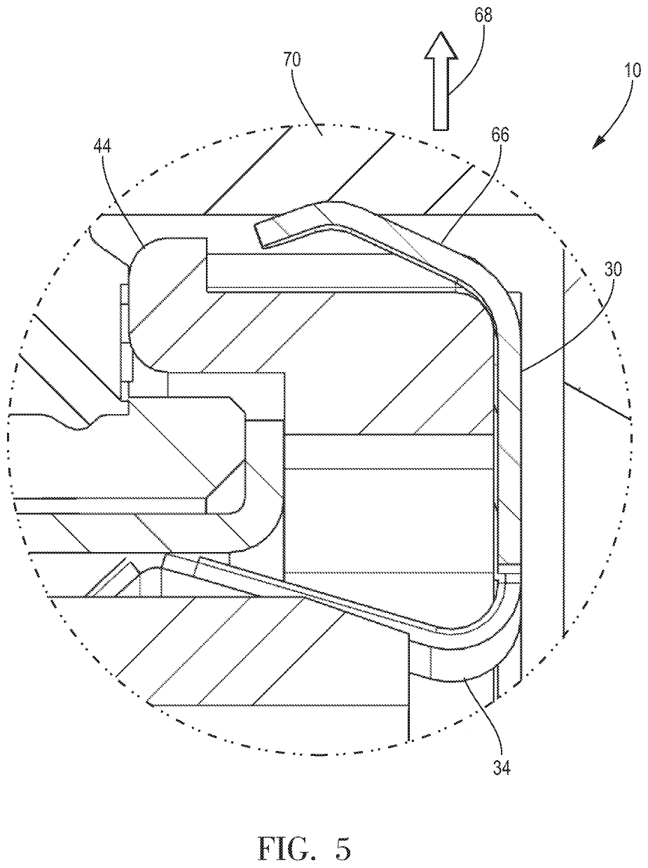

The contact-feature 32 or the contact-terminal 30 may be further configured to define a plurality of outer-contact-fingers 66 that are urged in an other-radial-direction 68 (FIG. 5) to make electrical contact with the interface 70 after the assembly 10 is assembled. In this example the other-radial-direction 68 corresponds to the radial-direction 40. However, similar to what was mentioned above, other configurations are envisioned where the other-radial-direction 68 is opposite to the radial-direction 40, either in a radially inward direction or a radially outward direction.

The assembly 10 may include a retainer 44 that defines a tab or hook 46 that fits into an opening 48 defined by the metallic-sleeve 22. The hook 46 and the opening 48 are configured to cooperate with each other to retain the metallic-sleeve 22 on the retainer 44 and prevent rotation of the metallic-sleeve 22 relative to the retainer 44 after the assembly 10 is assembled. The retainer 44 may also define a plurality of passageways 50 through which the plurality of inner-contact-fingers 34 passes after the assembly 10 is assembled, or at least the contact-terminal 30 and the retainer 44 are assembled. The plurality of passageways 50 and the plurality of inner-contact-fingers 34 cooperate to prevent rotation of the contact-terminal 30 relative to the retainer 44 after the assembly is assembled. The prevention of rotation of the various parts is advantageous as it helps to reduce wear of the various points of electrical contact used to form the electrical connection between the shielding-layer 12 and the boundary 16.

The assembly 10 may include a housing 52 that cooperates with a peripheral-seal 54 and a wire-seal 56 to cover and protect from moisture and other contaminates the parts inside the housing that form the electrical connection between the shielding-layer 12 and the boundary 16. The housing 52 may be further configure to support the shielded-cable 14 and provide the necessary features 60 so fasteners 58 can be used to fix or attach the assembly 10 to the boundary 16. The assembly 10 may include a lock-insert 62 that cooperates with a cover 64 to secure the wire-seal 56 and provide strain relief for the shielded-cable 14.

Accordingly, a shielded-cable pass-through assembly (the assembly 10) is provided that provides a convenient, economical, and reliable way to make an electrical contact between a shielding-layer of a shielded-cable and a boundary through which the shielded-cable passes.

While this invention has been described in terms of the preferred embodiments thereof, it is not intended to be so limited, but rather only to the extent set forth in the claims that follow.

1. A shielded-cable pass-through assembly configured to provide electrical contact between a shielding-layer of a shielded-cable (14) and a boundary through which the shielded-cable passes, said assembly comprising:
a metallic-sleeve that defines a shield-surface used to make electrical contact with a shielding-layer of a shielded-cable; and
a contact-terminal that defines a contact-feature used to make electrical contact with the boundary through which the shielded-cable passes, and defines a plurality of inner-contact-fingers extending from the contact-terminal in a longitudinal-direction parallel to a longitudinal-axis of the shielded-cable, wherein the plurality of inner-contact-fingers is urged in a radial-direction to make electrical contact with a contact-surface of the metallic-sleeve after the assembly is assembled.

2. The assembly in accordance with claim 1, wherein the boundary includes an interface and the contact-terminal defines a plurality of outer-contact-fingers urged in another-radial-direction to make electrical contact with an interface after the assembly is assembled.

3. The assembly in accordance with claim 1, wherein the assembly includes a retainer that defines a hook that fits into an opening defined by the metallic-sleeve, wherein the hook and the opening cooperate to retain the metallic-sleeve on the retainer and prevent rotation of the metallic-sleeve relative to the retainer after the assembly is assembled.

4. The assembly in accordance with claim 3, wherein the retainer defines a plurality of passageways through which the plurality of inner-contact-fingers passes after the assembly is assembled, wherein the plurality of passageways and the plurality of inner-contact-fingers cooperate to prevent rotation of the contact-terminal relative to the retainer after the assembly is assembled.

5. The assembly in accordance with claim 1, wherein the assembly includes a ferrule that is crimped around the shield-surface of the metallic-sleeve to urge the shielding-layer of the shielded-cable into electrical contact with the shield-surface.
